(19) United States
(12) Patent Application Publication
(10) Pub. No.: US 2002/0187816 A1
(43) Pub. Date: Dec. 12, 2002

(54) Handsfree apparatus

(76) Inventor: Jack Ou, Taipei City (TW)

Correspondence Address: David and Raymond Patent Group, 1050 Oakdale Lane, Arcadia, CA, 91006, US

(21) Appl. No.: 09/873,982

(22) Filed: Jun. 4, 2001

(51) Int. Cl. H04M 1/00

(52) U.S. Cl. 455/569; 455/573

(57) ABSTRACT

An improved handsfree apparatus of the present invention mainly comprises a plug-in part, a holder, wherein the plug-in part is a multi-bending structure to provide the holder an omnidirectional usage space, and the holder has a room to place the cell phone and is suitable for different specifications of cell phones, and an external microphone which has the characteristic that sound input/output are independent, and echo and interference of noise is avoided such that quality of communication is better and the structure of used handsfree apparatus has more diversifications.

### BACKGROUND OF THE INVENTION

1. Field of the Invention

The present invention relates to a handsfree apparatus, especially the one improving quality of communication and having an external plug-in microphone such that quality of communication is better.

2. Description of the Prior Art

With flourishing development of industries of wireless communication and cell phones, the direction of pursuing convenience and comfort of products is emphasized and every electric communication product tends to have better precision and quality.

Except for pure conversation, cell phones keep developing toward diversification. Both real image and internet increase additional value. Therefore, cell phones in future must make users to proceed communication, watching screens and talking without nestling ears on phones at the same time. However, if sound is broadcasted via speakers, private conversation can't be kept in secret. If users use earphones having wires, those wires may become an obstructer in the narrow space. Although it is not very inconvenient, promoting driving quality and improving all disadvantages are the final object for a designer. In this reason, disadvantages described above are just parts of all, and the present headphones and earphones are really not perfect designs, no matter in the aspect of exterior or structure, and need being improved.

Besides, the handsfree apparatuses on sale need to be plugged into the cigarette lighter directly, and electric waves of calling party and receiving party usually interference each other. In addition, habitually used handsfree apparatuses are not suitable for all manufacturers and types of cell phones.

The inventor of the present invention ruminated over the disadvantages resulted from the product described above and earnestly deliberated the way of improvement and innovation. After studying hard for a long period, the inventor eventually succeeded in inventing the handsfree apparatus having a header and housing plug-in components.

### SUMMARY OF THE INVENTION

The purpose of the present invention is to provide an improved handsfree apparatus, whereof a header plug-in component is set on the holder according to the way of sound source output, such as MOTOROLA L2000, SAMSUNG 3500, 6100, 8500 series, and PHS series in Japan, and is plugged into the phone jack of the cell phone at proper time to take out sound source and output via the speaker.

The second purpose of the present invention is to provide an improved hands free apparatus, in which the calling and receiving unit are set separately such that interference from each other because of echo is avoided to make quality of communication better.

Another purpose of the present invention is to provide an improved handsfree apparatus, which contains an independent communication unit, an external microphone. The microphone is the plug-in head of the header and used for making sound picked up more efficiently, and joining with the housing plug-in component of the holder via a sliding gear such that except for using the plug-in components to adjust the usage space of the holder, the user also can use the sliding gear to adjust the angle of the external microphone to make it pick up sound source more efficiently.

The improved handsfree apparatus achieving the purposes described above comprises a plug-in part and a body. The former is the structure of multi-bending and provide the holder with omnidirectional usage space, and the holder has a room for cell phone and is arranged in pair with different cell phone and, besides, an external microphone is set.

### BRIEF DESCRIPTION OF THE DRAWINGS

The drawings disclose an illustrative embodiment of the present invention which serves to exemplify the various advantages and objects hereof, and are as follows:

FIG. 1 3D view of the present invention, an improved handsfree apparatus;

FIG. 2 View of the practice of the handsfree apparatus with placing the cell phone;

FIG. 3 Magnified partial diagram of the external microphone of the handsfree apparatus

FIG. 4 Diagram of another practice method of the handsfree apparatus

[Diagram Remarks]

| | |
|---|---|
| 1 | Plug-in part |
| 11 | Body |
| 12 | Extended part |
| 2 | Holder |
| 22 | Plug-in terminal |
| 23 | Plug-in jack |
| 24 | Placing room |
| 25 | Connecting socket |
| 251 | Fixing teeth |
| 252 | Circular pit |
| 26 | Phone plug-in end |
| 27 | Fixing clip |
| 3 | Fixing bolt |
| 31 | Nut |
| 4 | Speaker |
| 5 | External microphone |
| 51 | Linking set |
| 52 | Tooth crown |
| 53 | Protruding circular points |
| 6 | Cell phone |
| 61 | Plug-in hole |

### DETAILED DESCRIPTION OF THE PREFERRED EMBODIMENT

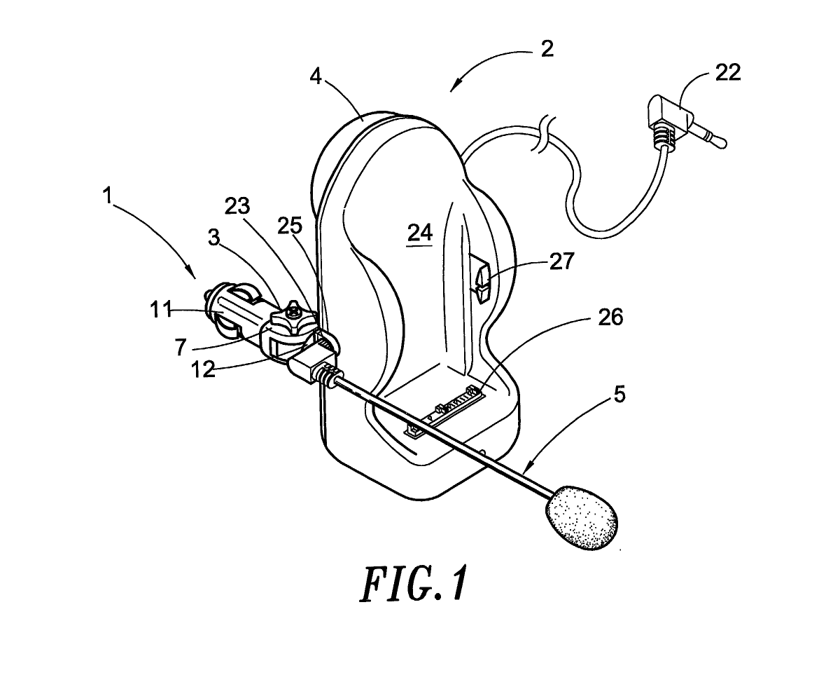

Referring to FIG. 1, the improved handsfree apparatus from the present invention mainly comprises a plug-in part 1 and a holder 2. The plug-in part 1 comprises the body of the plug-in part 11, an extended part 12, joints 7 of different direction separately used for joining the body 11 of the plug-in part and the extended part 12 together, and the extended part 12 and the holder 2 together, and a fixing bolt 3 for piercing through the joint 7 outside of each joint 7 and locked with a nut (not shown in figures). The holder 2 joining with the plug-in part 1 comprises a speaker 4, a plug-in terminal 22, a plug-in jack 23, a placing room 24 for cell phone and a connecting socket 25. In addition, there is an external microphone 5.

The speaker 4 is used to output sound source of the cell phone, and the internal circuit is connected with the circuit of the phone plug-in end 26 and the plug-in terminal 22 such that the function of automatically choosing the way of sound source signal input is performed.

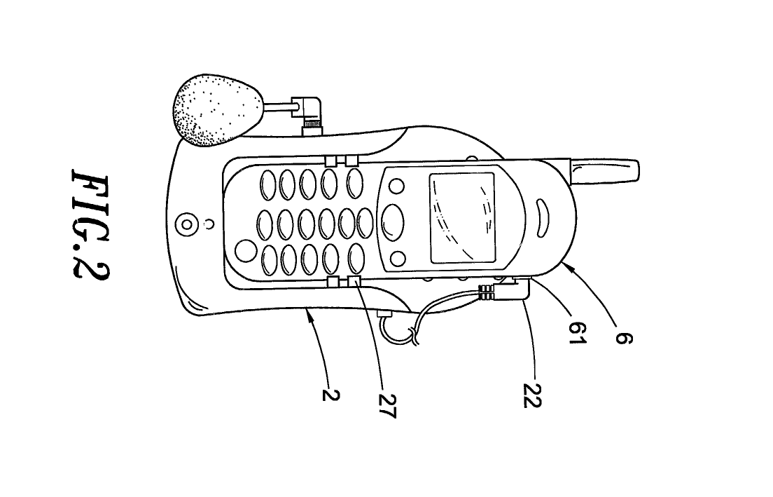

Referring to FIG. 2, which shows that the cell phone 6 (MOTOROLA L2000) is placed in the placing room, the cell phone 6 has a plug-in hole 61, which is used for plugging in the plug-in terminal 22 of the holder 2 to take out sound, at the left side of the front side. In this way, the present invention can provide the handsfree apparatus suitable for the cell phone MOTOROLA L2000 series. Before being plugged, the plug-in terminal 22 is suspended outside of the holder 2. After the cell phone 6 is placed into the placing room 24, the user just plugs the plug-in terminal 22 into the plug-in hole 61 of the fixed cell phone 6 such that sound can be broadcast via the speaker 4. The cell phone 6 can also be fixed between the holder 2 and the cell phone 6 by using the fixing clip 27.

Therefore, the position of the plug-in terminal of the present invention is able to be varied based on specifications of cell phones and different positions of the housing plug-in components while having the same feature.

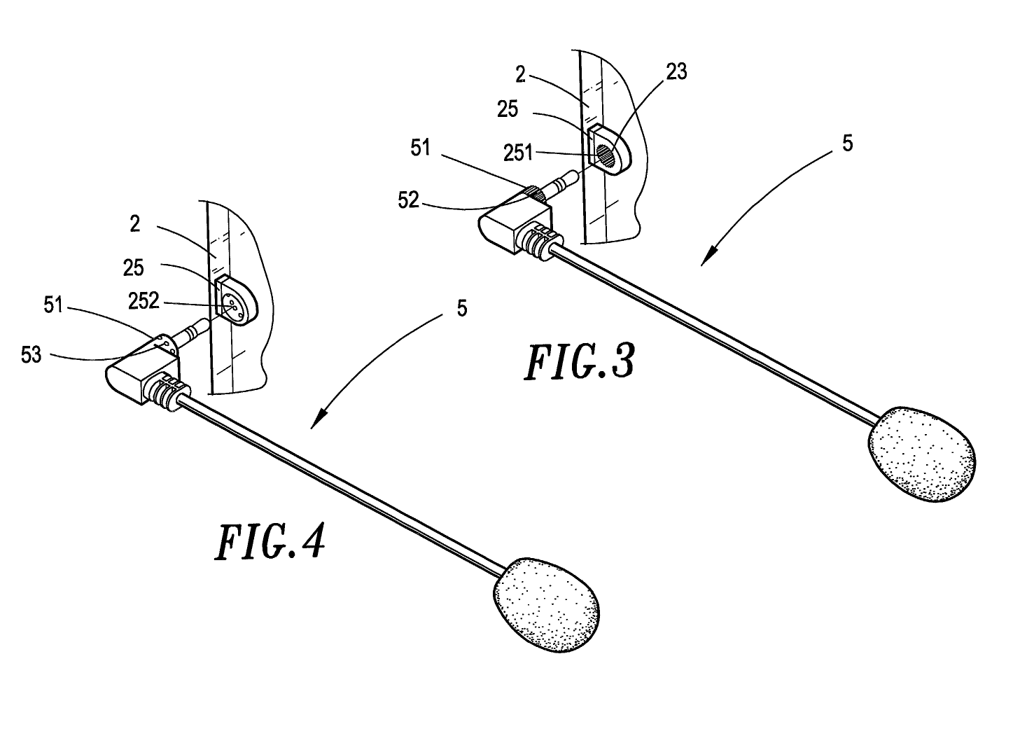

Referring to FIG. 3, the external microphone 5 is an independent unit, and is a header plug-in terminal component (phone jack). The microphone 5 has a linking set 51, on which tooth crowns are sculptured. A connecting socket 25 is set outside of the plug-in jack 23 of the holder 2, and fixing teeth 251 are set around the internal annular area of the connecting socket 25. In this way, after plugging, the microphone 5 can be joined with the connecting socket 25 of the holder 2 by the tooth crowns 52. The fixing teeth 251 of the connecting socket 25 of the holder 2 are engaged with the tooth crowns 52 of the external microphone 5, and the composition has the function of fixing and roughly rubbing such that the microphone 5 is not easy to droop or direction of the microphone is not easy to be out of control due to sliding. Therefore, except for using the plug-in part to adjust the usage space of the holder, the user also can adjust the angle between the external microphone 5 and the holder 2 to make the external microphone 5 pickup sound more omnidirectionally and effectively.

Referring to FIG.4, which shows another type of external microphone 5, protruding circular points 53 are set around the external annular area of the linking set 51, and corresponding circular pits 252 are set around the internal annular side of the connecting socket 25 outside of the holder 2. Using the circular pits 25 of the connecting socket 25 of the holder 2 to engage with the protruding circular points 52 of the external microphone 5 has the function of fixing and roughly rubbing, and thus the microphone is not easy to droop or the direction of the microphone is not easy to be out of control due to sliding such that except for using the plug-in part to adjust the usage space, the user also can use the sliding gear to adjust the angle between the external microphone and the holder to make the external microphone pick up sound more effectively.

The improved handsfree apparatus of the present invention has following advantages:

1. The present invention can be designed with different dies and plug-in terminals of different direction according to different specifications and types of cell phones.

2. Because of length and angle, the plug-in microphone picks up sound more effectively and is not easy to have echo interference.

3. By setting the plug-in components on the handsfree apparatus, the user just need to plug the plug-in component into the cell phone or place the cell phone on the holder of the handsfree apparatus before driving, and then talk easily under driving.

4. The opportunity of causing accidents resulted from talking under driving is lowered substantially.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An improved handsfree apparatus comprising at least a plug-in part and a holder, wherein said plug-in part comprises a body of said plug-in part, an extended part, a first joint for joining said body of said plug-in part and said extended part, a second joint of different direction from said first joint, joining said extended part and said holder, a first fixing bolt and a second fixing bolt respectively piercing through said first joint and second joint outside of said first joint and second joint and locked by a first and a second nut; and
wherein said holder joining with said plug-in part comprising: a speaker, a plug-in
terminal, a plug-in jack with setting a connecting socket outside and a placing
room for a cell phone, and a feature is that an external microphone can be plugged
into said plug-in part of said holder, and jointed tightly by structure of said
connecting socket to be fixed and roughly rubbed and is not easy to droop or
direction of said microphone is not easy to be out of controlling direction due
to sliding.

2. An improved handsfree apparatus as recited in claim 1, whereof said microphone
has a linking set which is sculptured with a plurality of tooth crowns, and a plurality
of fixing teeth are set around internal annular area of said connecting socket
outside of said plug-in jack of said holder such that said fixing teeth of said
connecting socket of said holder are engaged with said tooth crowns of said external
microphone to make said external microphone fixed and roughly rubbed.

3. An improved handsfree apparatus as recited in claim 1, whereof a plurality of
protruding circular points are set around outside annular area of said linking set
of said microphone and a plurality of corresponding circular pits are set around
internal annular area of said connecting socket outside of said holder such that
said circular pits of said connecting socket of said holder are engaged with said
protruding circular point of said external microphone and have a function of fixing
and roughly rubbing.

4. An improved handsfree apparatus as recited in claim 1, wherein said plug-in terminal
is used for sound source output, and an internal circuit of said holder can be connected to said plug-in terminal such that ways of sound signal broadcast can be chosen automatically.

5. An improved handsfree apparatus as recited in claim 1, wherein a position of said
plug-in terminal can varied according to different specifications of a cell phone
and different positions of a housing.
